(19) United States
(12) Patent Application Publication
(10) Pub. No.: US 2008/0295722 A1
(43) Pub. Date: Dec. 4, 2008

(54) METHOD AND APPARATUS FOR PRE-STAGING PRINTING PLATES

(76) Inventors: Gordon D. Andrew, Delta (CA); William Yuen, Vancouver (CA)

Correspondence Address: David A. Novais;Patent Legal Staff, Eastman Kodak Company, 343 State Street, Rochester, NY, 14650-2201, US

(21) Appl. No.: 11/755,822

(22) Filed: May 31, 2007

(51) Int. Cl. B41F 27/00

(52) U.S. Cl. 101/477; 101/485

(57) ABSTRACT

A plate making method comprises pre-aligning a printing plate (50) to an imaging drum (20) of a plate making machine (10) while the printing plate is moving along a plate supply path (60) to the plate making machine. The printing plate is located on a motorized shuttle carriage (90) during the moving and the pre-aligning to the imaging drum comprises rotating into alignment with a lateral alignment surface (110, 120) a lateral edge of the printing plate by moving the printing plate laterally to contact the lateral alignment surface. The method of the invention can further comprise moving the printing plate away (460) from the lateral alignment surface to a predetermined position at which position the plate is aligned with alignment pins or other alignment features on the imaging drum. The method of pre-aligning the plate to the imaging drum can comprise pre-aligning (480) the printing plate to a cylindrical axis of the imaging drum.

### FIELD OF THE INVENTION

The invention relates to printing and in particular, to providing pre-aligned printing plates to plate making machines.

### BACKGROUND OF THE INVENTION

Printing plates may be imaged on a plate making machine and then transferred to a printing press. Once on the printing press, the images from the printing plates are transferred to paper or other suitable substrates. It is important that images printed using a printing press be properly aligned with the substrate on which they are printed. Obtaining such alignment typically involves carefully aligning a reference edge of a printing plate with pins or other features on the plate making machine, detecting one reference point on an orthogonal edge of the printing plate (i.e. orthogonal to the reference edge) at a known distance from the reference pins, imaging the printing plate; and using the reference edge and the orthogonal edge reference point to align the printing plate on a drum of the printing press.

One common technique of aligning the printing plate on the drum of a printing press involves using the reference edge and the orthogonal edge reference point to align the printing plate on a punching machine and punching registration holes in the printing plate. The printing plate may then be aligned on the drum of the printing press with registration pins that project through the registration holes.

Traditionally mechanical alignment pins have been used to align the plate to be imaged to the drum of a platesetter. This is not a flexible arrangement. The pins have to be mounted in predetermined positions. There are also reliability challenges in consistently and accurately loading the plate into contact with the pins. It is also difficult to define sets of pins that allow a wide range of plate formats to be imaged whilst not interfering with one another. For these reasons there has more recently been major efforts directed towards arrangements in which no pins are employed, and the printing plates are either aligned to the imaging drum by other means, or the image is rotated to line up with the skew plate.

A further important aspect of the entire plate alignment process is the physical method of loading of the plate onto the imaging drum. While there is some description in the prior art of systems for correcting the placement of a plate on a drum, such as, for example, U.S. Pat. Nos. 6,615,724, 6,371,021, and 5,634,406, it is generally more effective to get the plate loaded as close to perfectly aligned as possible during the initial loading step, while the imaging head and imaging drum of the platemaking machine are still engaged in imaging other plates or are otherwise occupied. To this end, it would be hugely beneficial if the printing plate were supplied to the imaging drum with a printing plate leading edge that is pre-aligned with the cylindrical axis of the imaging drum. In the case of a plate making machine employing pins, it would be particularly beneficial if the plate were supplied pre-aligned with the pins on the imaging drum. This pre-alignment of plates to an imaging drum before the plate gets to the actual imaging drum, is referred to as pre-staging.

### SUMMARY OF THE INVENTION

The present invention constitutes a method for supplying a printing plate to a plate making machine, the method comprising pre-aligning the printing plate to an imaging drum of the plate making machine while the printing plate is moving along a plate supply path to the plate making machine. The printing plate is located on a motorized shuttle carriage during the moving and the pre-aligning to the imaging drum comprises rotating into alignment with a lateral alignment surface a lateral edge of the printing plate. The rotating into alignment comprises moving the printing plate in a lateral translational direction to contact the lateral alignment surface. The method of the invention can further comprise moving the printing plate away from the lateral alignment surface to a predetermined position at which position the plate is aligned with alignment pins or other alignment features on the imaging drum. The method of pre-aligning the plate to the imaging drum can comprise pre-aligning the printing plate to a cylindrical axis of the imaging drum.

In a further aspect the present invention constitutes an apparatus for executing the method of the invention. In this aspect the invention is an apparatus for supplying a printing plate to a plate making machine along a plate supply path, the apparatus configured to pre-align the printing plate to an imaging drum of the plate making machine while the printing plate is moving along the plate supply path to the plate making machine. The apparatus can comprise a motorized shuttle carriage for moving the printing plate while the printing plate is located on the motorized shuttle carriage, and the apparatus is configured to pre-align the printing plate to the imaging drum by rotating into alignment with a lateral alignment surface a lateral edge of the printing plate. The motorized shuttle carriage is configured to move the printing plate in a lateral translational direction to contact the lateral alignment surface. The motorized shuttle can further be configured to move the printing plate away from the lateral alignment surface to a predetermined position at which position it the plate is aligned with alignment pins or other alignment features on the imaging drum. The motorized shuttle carriage may comprise the lateral alignment surface and can have conveyor belts to move the printing plate in the two mutually opposite lateral directions, during which motion vacuum may be applied to the printing plate. This vacuum is removable during the period when the printing plate is being rotated into alignment. The lateral alignment surface can be discontiguous and can comprise two alignment pins.

### BRIEF DESCRIPTION OF THE DRAWINGS

In the drawings which illustrate non-limiting embodiments of the invention:

FIG. 1 is a schematic diagram of an external drum-type plate making machine served by a shuttle system and a load table;

FIG. 2 shows a printing plate shuttle system;

FIG. 3 shows the printing plate shuttle system of FIG. 2 in more detail;

FIG. 4 shows a section of the plate shuttle system of FIG. 3 in more detail;

FIG. 5 shows a printing plate being moved laterally on a motorized shuttle carriage;

FIG. 6 shows a printing plate contacting a de-skewing sidewall of a motorized shuttle carriage;

FIG. 7 shows a printing plate rotated into alignment with a de-skewing sidewall of a motorized shuttle carriage;

FIG. 8 shows an aligned printing plate being moved into alignment with mechanical features on an imaging drum (not shown);

FIG. 9 shows two printing plates being moved laterally in opposite directions on a motorized shuttle carriage;

FIG. 10 shows two printing plates contacting two mutually facing de-skewing sidewalls of a motorized shuttle carriage;

FIG. 11 shows two printing plates being rotated into alignment with two mutually facing de-skewing sidewalls of a motorized shuttle carriage;

FIG. 12 shows two aligned printing plates being moved laterally in opposite directions into alignment with mechanical features on an imaging drum (not shown);

FIG. 13 is a flow diagram providing the steps of the present invention; and

FIG. 14 is a flow diagram providing the steps of the present invention.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

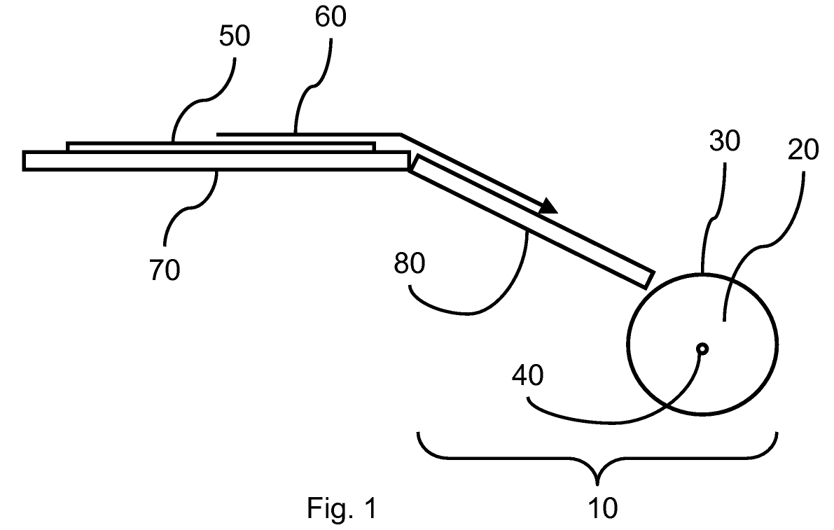

In FIG. 1 plate making machine 10 comprises an imaging drum 20 having cylindrical surface 30, imaging drum 20 being rotatable about cylindrical axis 40. Printing plate 50 is supplied to imaging drum 20 along plate supply path 60 over plate shuttle system 70 of the present invention and load table 80 of plate making machine 10. Load table 80 can be inclined as shown, in order that plate 50 can be provided to imaging drum 20 at a desired angle. Imaging drums and the load tables supplying with printing plates have been described extensively in the prior art and will not be addressed further here. The present invention pertains to a plate shuttle system 70 that pre-stages printing plate 50 as it travels along plate supply path 60 over shuttle system 70.

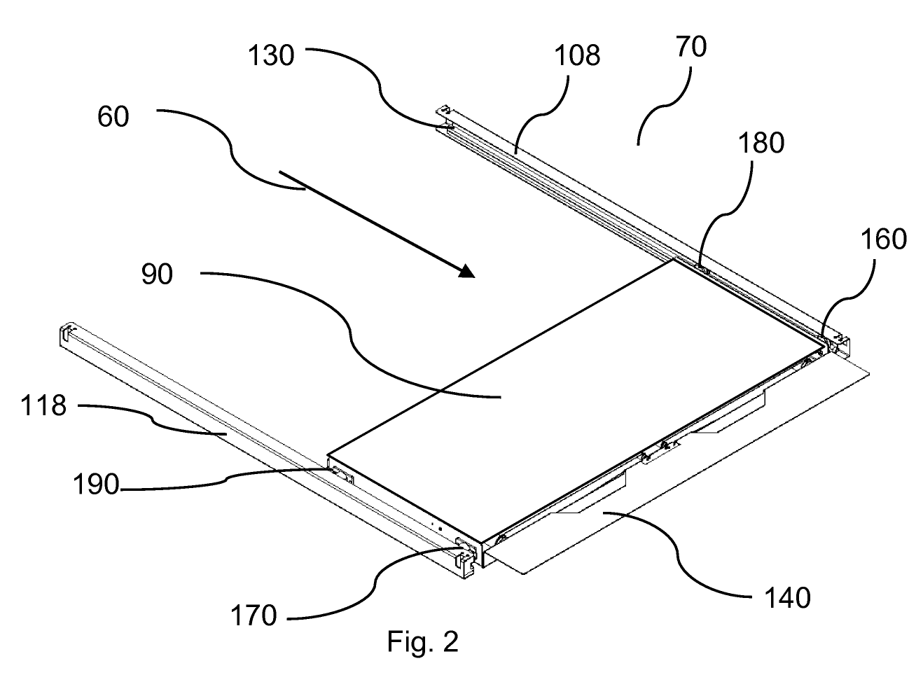

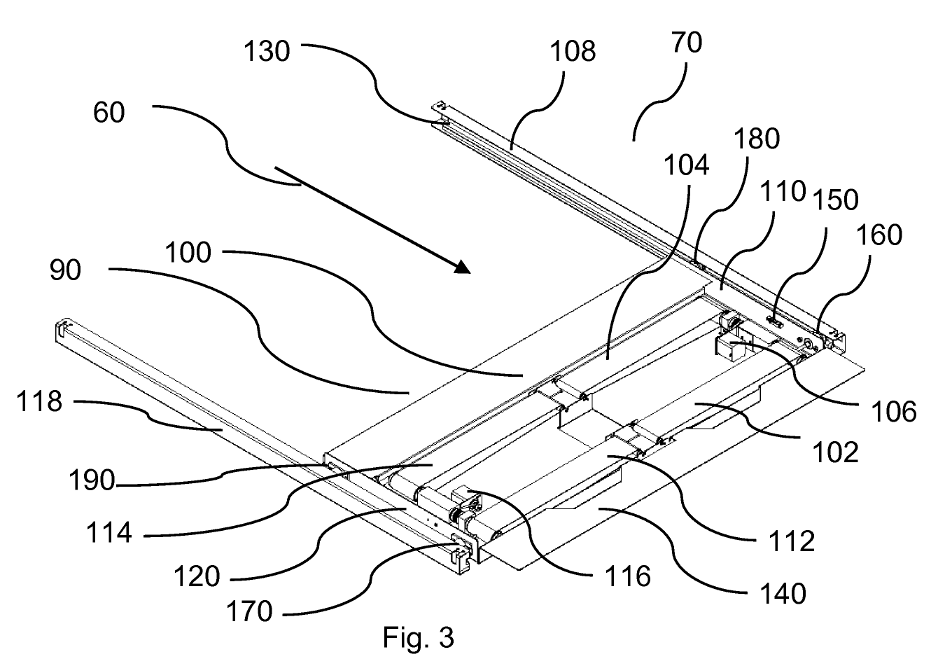

FIG. 2 shows plate shuttle system 70 of the present invention in more detail. Printing plate 50 is omitted from FIG. 2 for the sake of clarity. Printing plate 50 of FIG. 1 is supplied along plate supply path 60 by motorized shuttle carriage 90 which moves parallel to rail mounting brackets 108 and 118 by means of a rack and pinions system. Motorized shuttle carriage 90 is only depicted schematically in FIG. 2, its more detailed structure being given in FIG. 3. Rack gear 130 is attached to rail mounting bracket 108. Motorized shuttle carriage 90 comprises pinion gears 160 and 180. At least one of pinion gear 160 and pinion gear 180 is driven by a shuttle carriage engine (not shown). An equivalent arrangement exists with respect to rail mounting bracket 118, where the rack gear is not shown. Motorized shuttle carriage 90 comprises pinion gears 170 and 190. At least one of pinion gear 170 and pinion gear 190 is driven by an engine (not shown). Alternative arrangements for moving motorized shuttle carriage 90 can also be used, including but not limited to belt-driven systems. When motorized shuttle carriage 90 reaches plate out-feed support 140, printing plate 50 can be delivered to load table 80 of plate making machine 10.

FIG. 3 shows motorized shuttle carriage 90 in more detail. In the embodiment of the present invention depicted in FIG. 3, pinion gears 180 and 190 are driven by a shuttle carriage engine (not shown) housed under plate in-feed support 100, while pinion gears 160 and 170 are not driven. Alternatively, pinion gears 160 and 170 can be driven while pinion gears 180 and 190 are free-running. In yet a further embodiment of the present invention all four pinion gears 160, 170, 180, and 190 can be synchronously driven. Conveyor belts 102 and 104 are driven by conveyor belt engine 106, while conveyor belts 112 and 114 are driven by conveyor belt engine 116.

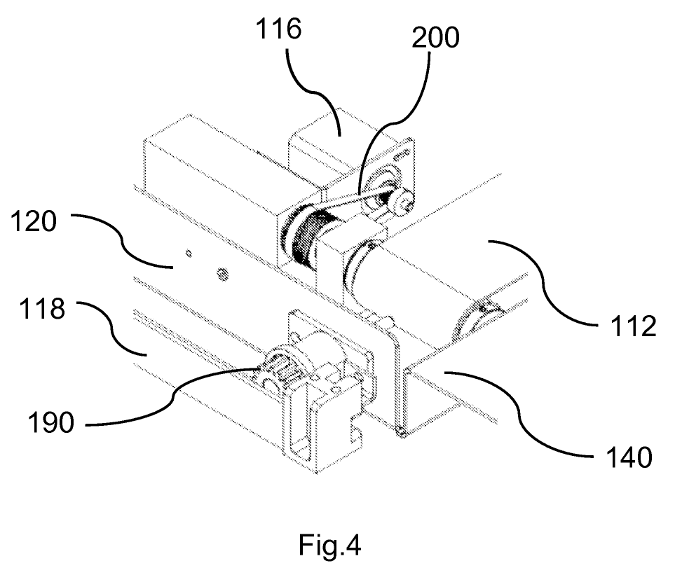

FIG. 4 shows one corner of motorized shuttle carriage 90 in yet more detail, with the outer cladding of rail mounting bracket 118 removed to show pinion gear 190 more clearly. It also shows how conveyor belt 112 can be driven by conveyor belt engine 116 via an engine belt 200. A similar arrangement can exist for conveyor belt engine 106 and conveyor belt 102. Conveyor belts 104 and 114 are driven in similar fashion by the two conveyor engines 116 and 106. Conveyor belt engines 106 and 116 can be any form of engine, including but not limited to stepper motors. Conveyor belt engine 106 can drive conveyor belts 102 and 104 in the same direction as what engine 116 drives conveyor belts 112 and 114, or it can drive conveyor belts 102 and 104 in the opposite direction from what engine 116 drives conveyor belts 112 and 114, as required by the operation of the system, as described below. Motorized shuttle carriage 90 further comprises de-skewing side walls 110 and 120, as well as at least one plate sensor 150 arranged on or near de-skewing side wall 110. An equivalent sensor can be arranged on de-skewing side wall 120, but is not visible in FIG. 4, being obscured by de-skewing side wall 120. De-skewing side wall 110 and de-skewing side-wall 120 are both perpendicular to cylindrical axis 40, and they are parallel to each other. Note that the operational surfaces of de-skewing side walls 110 and 120 are the surfaces mutually facing each other.

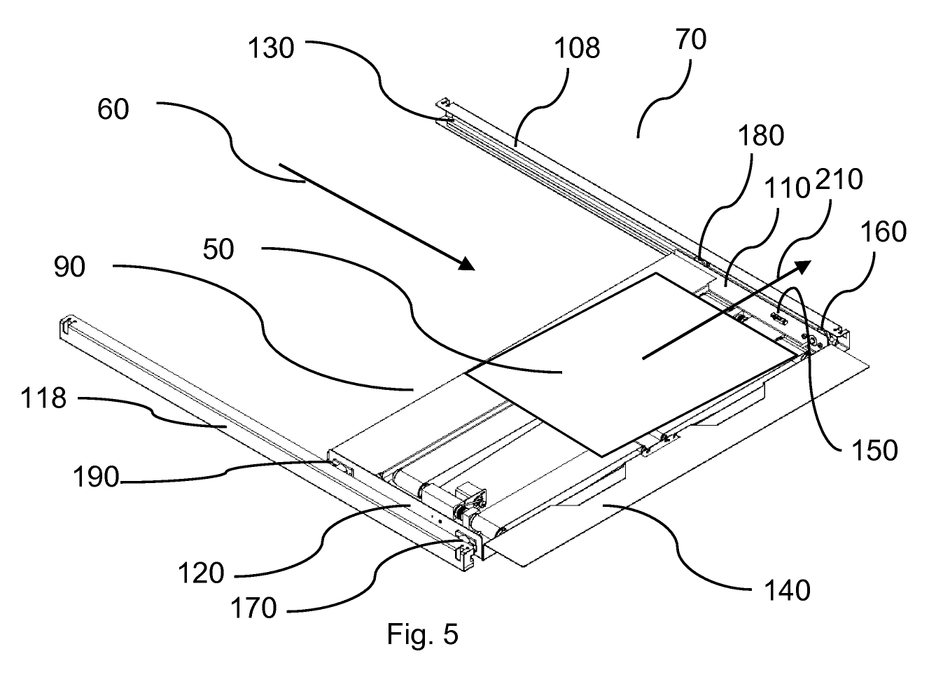

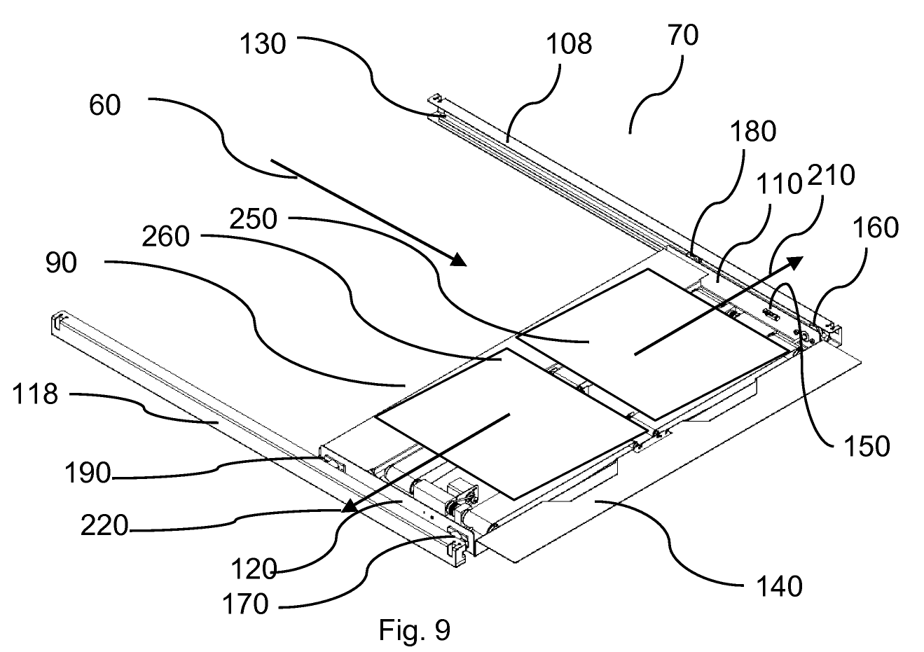

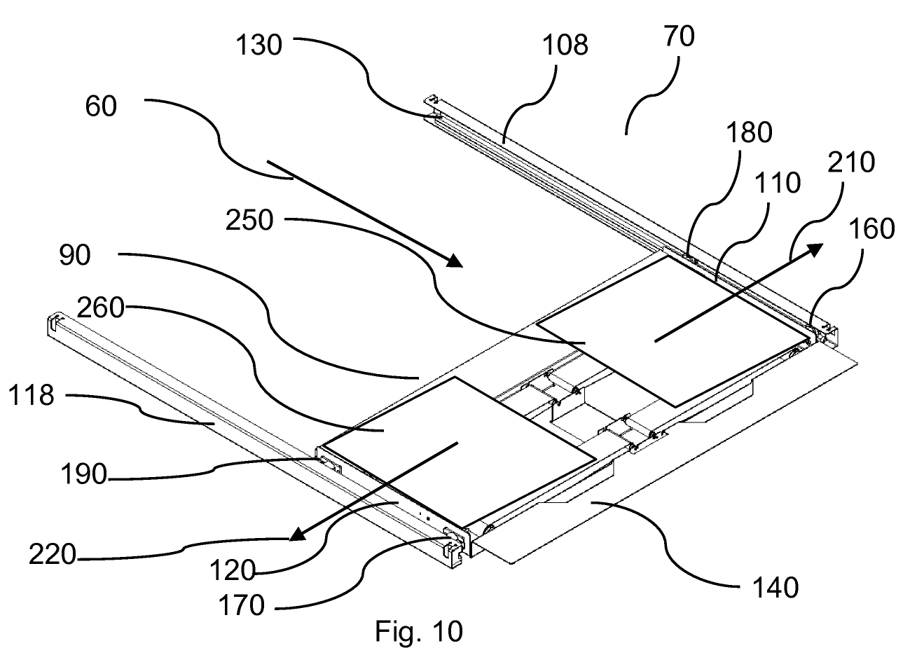

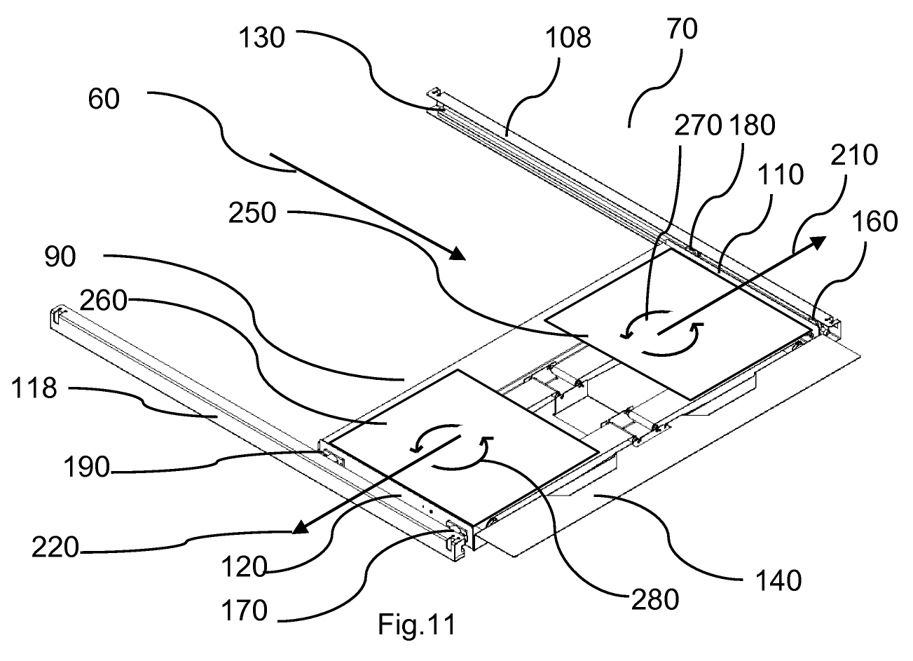

In the present specification the term “main translational direction” is used to describe the direction in which an object positioned on shuttle carriage 90 is translated by motorized shuttle carriage 90 when it is moving towards plate out-feed support 140 and conveyor belt engines 106 and 116 are turned off. The term “lateral translational direction(s)” is used to describe any one (or both) of the two mutually opposite directions 210 (see FIGS. 5-12) and 220 (see FIGS. 9-12) in which moving conveyor belts 102, 104, 112, and 114 can translate an object positioned on top of them when motorized shuttle carriage 90 is stationary. The lateral translation direction is perpendicular to the main translational direction. The phrase “lateral edge of a printing plate” is used to describe any one of the two edges of a rectangular printing plate that are substantially, though not necessarily perfectly, parallel to the main translational direction of the printing plate when the printing plate is positioned on shuttle carriage 90. The term “plane of motion” is used to describe the plane containing both the main translational direction and the lateral translational direction(s). This is the plane in which any object placed on any of conveyor belts 102, 104, 112, and 114 will move if any one or more of motorized shuttle carriage 90, and/or any one or more of conveyor belts 102, 104, 112 and 114 were to be in operation. In the present specification the term “lateral alignment surface” is used to describe surfaces that intersect the plane of motion along the main translational direction and that face printing plate 50. In FIG. 3 and FIG. 4 de-skewing side walls 110 and 120 are non-limiting examples of lateral alignment surfaces and are shown as being perpendicular to the lateral translational direction(s). In an alternative embodiment of the present invention, de-skewing side walls 110 and 120 can be sloped and only intersect the plane of motion along the main translational direction to form an obtuse or acute angle with plane of motion, rather than specifically a right angle as in FIGS. 3 and FIG. 4. In the embodiments of the present invention described in the Figures in this specification, the lateral alignment surfaces are the mutually facing surfaces of de-skewing side walls 110 and 120.

In yet another alternative embodiment of the present invention, the two lateral alignment surfaces do not have to be contiguous surfaces, but may instead each be defined by at least two non-contiguous mechanical features, such as but not limited to pins, capable of contacting the plate at two points, located near the edge of the plate shuttle system, and that are arranged along a line that is parallel to the main translational direction.

In the operation of plate making machine 10 and plate shuttle system 70, as shown in FIGS. 5-8, printing plate 50 is placed on motorized shuttle carriage 90, printing plate 50 having a lateral edge that is substantially, but in practice not perfectly, parallel to the lateral alignment surface defined by de-skewing side walls 110 and 120 of FIG. 3. Printing plate 50 moves along plate supply path 60. In so moving, printing plate 50 is supported on plate in-feed support 100 and on conveyor belts 102,104, 112, and 114, none of which, for the sake of clarity, are numbered in FIGS. 5-12, the numbering being taken from FIG. 3. While motorized shuttle carriage 90 is in transit along plate supply path 60, at least one of conveyor belt engine 106 and 116 (numbering again taken from FIG. 3) can be tuned on to move printing plate 50 toward one of de-skewing side wall 110 (in lateral translational direction 210) and de-skewing side-wall 120 (in lateral translational direction 220). In FIGS. 5-8 lateral translational directions 210 and de-skewing side wall 110 have been selected by way of example.

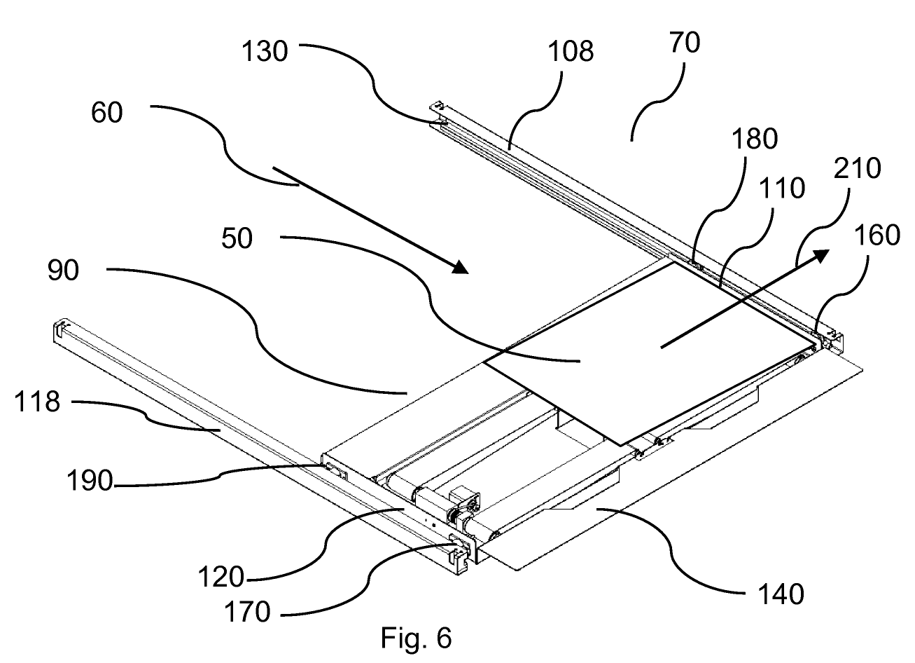

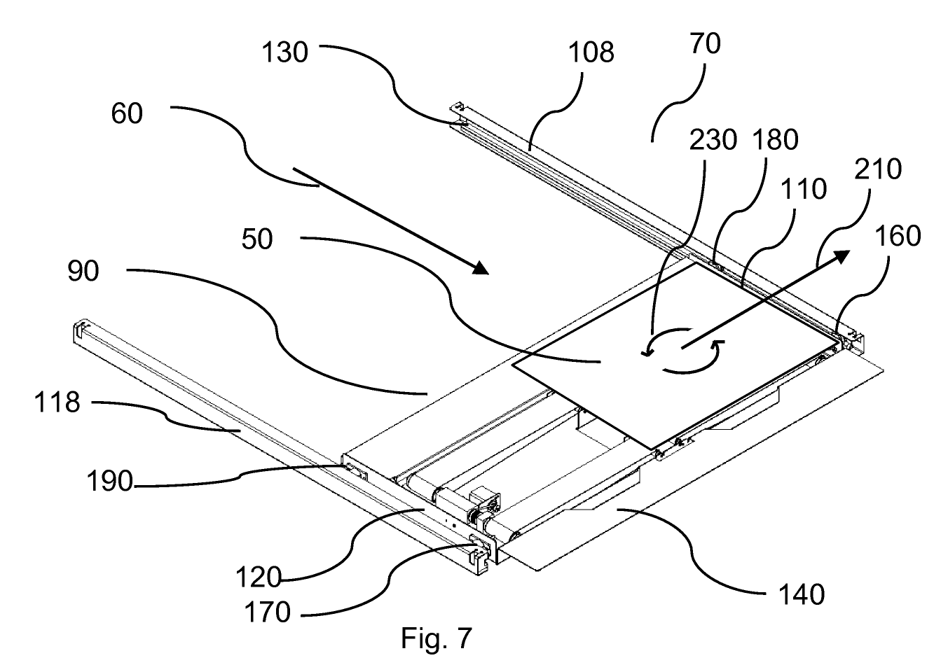

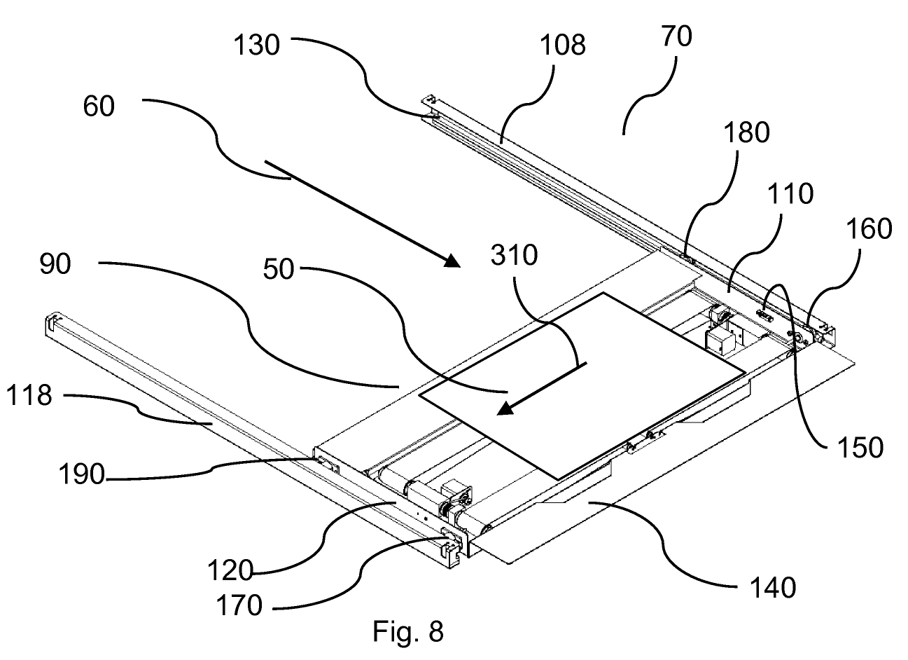

When the lateral edge of the plate moves over plate sensor 150, plate sensor 150 locates the plate edge. The plate edge-to-lateral alignment surface distance is then determined from this known plate edge location. A variety of sensor types can be employed, including but not limited to optical sensors. Conveyor belt engine 106 continues to operate until conveyor belts 102 and 104 have traveled a distance greater than the plate edge-to-lateral alignment surface distance. Upon contacting de-skewing side wall 110, as shown in FIGS. 6 and 7, printing plate 50 will rotate slightly in the plane of motion, as indicated by rotation arrow set 230, and align its lateral edge to de-skewing side wall 110 by pushing against de-skewing side wall 110. The distance by which the travel of conveyor belts 102 and 104 exceeds the plate edge-to-lateral alignment surface distance, is chosen large enough to ensure that the rotation of plate 50 is completed. Once the rotation is completed, conveyor belt engine 106 is operated in the reverse direction and conveyor belts 102 and 104 also reverse their direction of motion to move plate 50 a predetermined distance in direction 310 away from de-skewing side wall 110, as shown in FIG. 8. The predetermined distance may be chosen to line up plate 50 with pins or other locating mechanisms on imaging drum 20. While the lateral edge of plate 50 moves in the reverse direction over plate sensor 150, plate sensor 150 can optionally be used to confirm the motion of plate 50. Printing plate 50 may similarly be slightly rotated and aligned against de-skewing side wall 120 and detected by a plate sensor mounted there. In the present specification, the phrase “rotating into alignment” is used to describe this process of slight rotation of an object to align it with a lateral alignment surface. In the case where one single printing plate 50 is positioned on motorized shuttle carriage 90, all of conveyor belts 102, 104, 112 and 114 can be moving in the same direction to move printing plate 50 towards one of de-skewing side wall 110 and de-skewing side-wall 120.

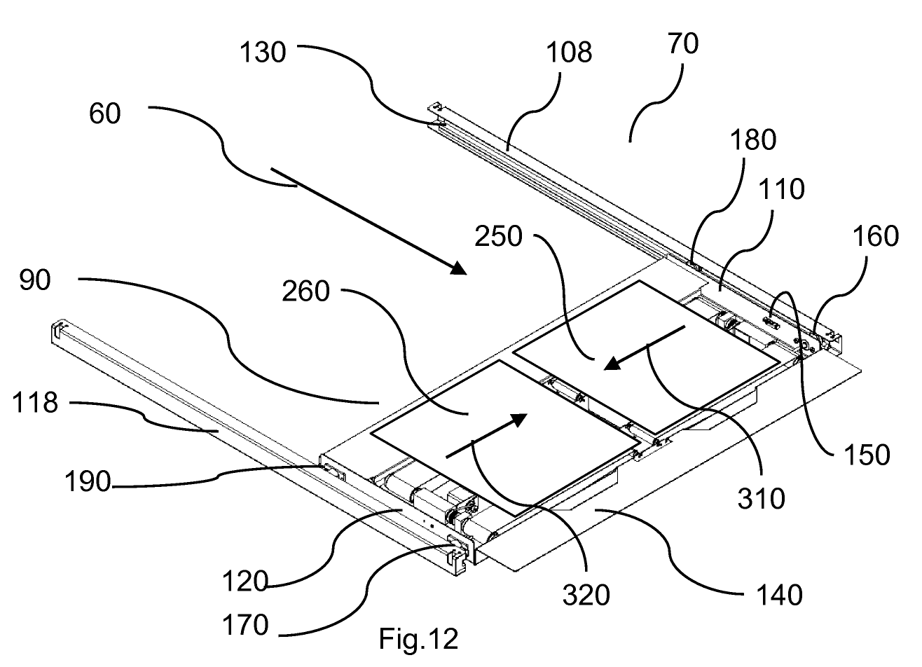

In a further embodiment of the present invention, shown in FIGS. 9-12, two printing plates 250 and 260 are positioned simultaneously next to each other on motorized shuttle carriage 90 with lateral edges substantially, but in practice not perfectly, aligned with de-skewing side walls 110 and 120. Printing plate 250 is largely supported by conveyor belts 102 and 104 and printing plate 260 by conveyor belts 112 and 114. In such a case, printing plate 250 may be rotated into alignment with de-skewing side wall 110 while printing plate 260 is rotated into alignment with de-skewing side wall 120. To achieve this, conveyor belts 102 and 104 are driven by conveyor belt engine 106 such that their top surfaces move towards de-skewing side wall 110, while conveyor belts 112 and 114 are driven by conveyor belt engine 116 such that their top surfaces move towards de-skewing side wall 120. This allows each of the two printing plates 250 and 260 to be rotated into alignment with lateral alignment surface 110 and 120 respectively, indicated by rotation arrow sets 270 and 280 respectively, even as they are being translated towards plate out-feed support 140, thereby improving throughput. As with the example of a single plate being rotated into alignment, the various conveyor belts 102, 104, 112, and 114, driven by conveyor belt engines 106 and 116, may continue to move as plates 250 and 260 rotate. The extent of this motion after detection of the plate edges by the plate sensors is again predetermined to ensure that the rotation of both plates is completed. Here again, conveyor belt engines 106 and 116 are then reversed so as to rotate the top sections of various conveyor belts 102, 104, 112, and 114 away from their nearest de-skewing sidewalls. The edges of plates 250 and 260 are detected by plate sensor 150 and its equivalent near de-skewing sidewall 120, and the motion of conveyor belts 102, 104, 112, and 114 is maintained, plate 250 in direction 310 and plate 260 indirection 320, until the two plates are lined up with pins or other locating mechanisms on the imaging drum 20. This is shown in FIG. 12. The extent of this reverse motion may differ between conveyor belts 102 and 104 on the one hand, and conveyor belts 112 and 114 on the other, depending on the exact positions of the alignment features on imaging drum 20.

In both embodiments described herein, conveyor belts 102, 104, 112, and 114 can be vacuum conveyor belts to better hold printing plates during motion. To the extent that vacuum conveyor belts are extensively described in the prior art, they will not be expanded upon further here. When a given printing plate reaches its intended de-skewing side wall, the vacuum may be removed to facilitate the rotation of the relevant printing plate during the process of rotation into alignment with the relevant de-skewing side wall. To this end, if plate 50 is being moved to de-skewing sidewall 110, then plate sensor may optionally 150 be used to detect the lateral edge of plate 50 and that information may be used to time the switching off of the vacuum.

The lateral alignment surfaces (de-skewing side walls 110 and 120) are designed and oriented to intersect the plane of motion along lines that are perpendicular to the cylindrical axis 40 of imaging drum 20. The lateral alignment surfaces are thereby pre-aligned to the cylindrical axis 40 of the imaging drum 20. This allows plate shuttle system 70 of the present invention to pre-stage (pre-align) printing plates 50, 250, or 260 to imaging drum 20 in order to thereby expedite loading of the plates onto cylindrical surface 30 of imaging drum 20. In a first aspect the present invention therefore constitutes method for supplying a printing plate to a plate making machine, the method comprising aligning a lateral edge of the printing plate to a lateral alignment surface while the printing plate is moving along a plate supply path to the plate making machine, thereby pre-staging the printing plate in that the printing plate is supplied to the imaging drum already aligned to that imaging drum. In a second aspect the present invention constitutes an apparatus for supplying a printing plate to a plate making machine, the apparatus being capable of aligning a lateral edge of the printing plate to a lateral alignment surface while the printing plate is moving along a plate supply path to the plate making machine, thereby pre-staging the printing plate in that the printing plate is supplied to the imaging drum already aligned to that imaging drum. The method and apparatus of the present invention therefore allow a substantial reduction in the time required for translating and aligning a printing plate for loading on to an imaging drum, thereby providing an important and useful increase in throughput, a critical factor for the printing plate making industry.

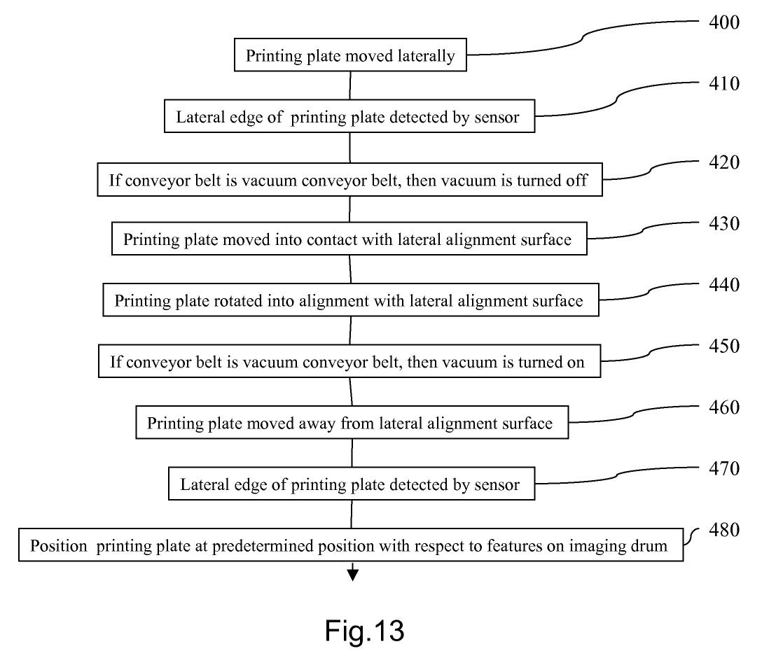

The method of the present invention is summarized in FIG. 13, which is a flow diagram providing the steps of the invention, numbered in parentheses, at the hand of parts numbering shown in FIGS. 1-12. A printing plate 50, located on a motorized shuttle carriage 90 is in transit along a plate supply path 60 to an imaging drum 20 of a plate making machine 10. While so in transit, printing plate 50 is moved laterally (400) in direction 210 using at least one conveyor belt 102, 104, 112, 114, which conveyor belt can be a vacuum conveyor belt. The lateral edge of printing plate 50 is detected (410) by sensor 150. If at least one conveyor belt 102, 104, 112, 114 is a vacuum conveyor belt, the vacuum can be turned off (420) when, or before, printing plate 50 makes contact with a lateral alignment surface 110. Based on the detection of the lateral edge of the printing plate, printing plate 50 is moved into contact (430) with a lateral alignment surface 110, which lateral alignment surface can be a lateral alignment surface of the motorized shuttle carriage. The conveyor belt motion is maintained, based upon the detection of the lateral edge of printing plate 50, until printing plate 50 is rotated into alignment (440) with a lateral alignment surface in the form of de-skewing sidewall 110. If at least one conveyor belt 102, 104, 112, 114 is a vacuum conveyor belt, the vacuum can be turned on (450) after the rotation into alignment has been completed. The conveyor belt 102, 104, 112, 114 is reversed and printing plate 50 is moved away (460) from lateral alignment surface 110 in direction 310. The lateral edge of printing plate 50 is again detected (470) by sensor 150 and the lateral motion of printing plate 50 is maintained to position (480) printing plate 50 at a predetermined position, in which position printing plate 50 is aligned with mechanical features on imaging drum 20.

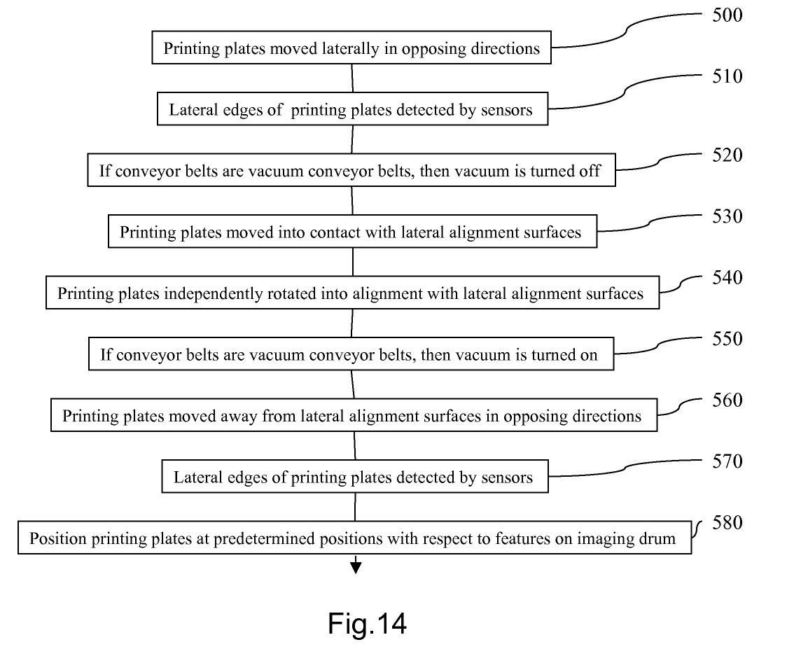

In the case of two printing plates 250 and 260 being loaded on motorized shuttle carriage 90, the method of the present invention is summarized in FIG. 14, which is a flow diagram providing the steps of the invention, numbered in parentheses, at the hand of parts numbering shown in FIGS. 1-12. Printing plates 250 and 260, located on a motorized shuttle carriage 90 are in transit along a plate supply path 60 to an imaging drum 20 of a plate making machine 10. While so in transit, printing plates 250 and 260 are moved laterally (500) in directions 210 and 220 respectively, using at least one conveyor belt 102 and 104 for printing plate 250 and at least one conveyor belt 112 and 114 for printing plate 260, which conveyor belts can be a vacuum conveyor belts. The lateral edge of printing plate 250 is detected (510) by sensor 150 and the lateral edge of plate 260 is detected by an equivalent sensor positioned on or near de-skewing sidewall 120. If at least one conveyor belt 102, 104, 112, 114 is a vacuum conveyor belt, the vacuum can be turned off (520) when, or before, printing plate 250 makes contact with a de-skewing sidewall 110 or printing plate 260 makes contact with a de-skewing sidewall 120. Based on the detection of the lateral edges of printing plates 250 and 260, printing plates 250 and 260 are moved into contact (530) with lateral alignment surfaces in the form of de-skewing sidewalls 110 and 120 respectively, which lateral alignment surfaces can be a lateral alignment surface of the motorized shuttle carriage. The conveyor belt motion is maintained, based upon the detection of the lateral edges of printing plates 250 and 260, until printing plates 250 and 260 are rotated into alignment (540) with lateral alignment surfaces in the form of de-skewing sidewall 110 and de-skewing sidewall 120, respectively. If at least one conveyor belt 102, 104, 112, 114 is a vacuum conveyor belt, the vacuum can be turned on (550) after the rotation into alignment has been completed. The conveyor belt 102, 104, 112, 114 is reversed and printing plate 250 and 260 are moved away (560) from the lateral alignment surfaces 110 and 120 in directions 310 and 320 respectively. The lateral edges of printing plates 250 and 260 are again detected (570) by the two detectors 150 and its equivalent, and the lateral motions of printing plates 250 and 260 are maintained to position (580) printing plate 250 and 260 at a predetermined positions, in which positions printing plates 250 and 260 are aligned with mechanical features on imaging drum 20. The motions of the two plates 250 and 260 do not have to be simultaneous, as the sets of conveyor belts 102 and 104 on the one hand, and conveyor belts 102 and 114 on the other hand, can operate independently.

The invention has been described in detail with particular reference to certain preferred embodiments thereof, but it will be understood that variations and modifications can be effected within the scope of the invention.

### PARTS LIST

10 plate making machine (platesetter)
20 imaging drum
30 cylindrical surface
40 cylindrical axis
50 printing plate
60 plate supply path (main translational direction)
70 shuttle system
80 load table
90 motorized shuttle carriage
100 plate in-feed support
102 conveyor belt
104 conveyor belt
106 conveyor belt engine
108 rail mounting bracket
110 de-skewing side wall (lateral alignment surface)
112 conveyor belt
114 conveyor belt
116 conveyor belt engine
118 rail mounting bracket
120 de-skewing side wall (lateral alignment surface)
130 rack gear
140 plate out-feed support
150 plate sensor
160 pinion gear
170 pinion gear
180 pinion gear
190 pinion gear
200 engine belt
210 lateral translational direction
220 lateral translational direction
230 rotation arrow set
250 printing plate
260 printing plate
270 rotation arrow set
280 rotation arrow set
310 lateral translational direction: opposite of 210
320 lateral translational direction: opposite of 220
400 printing plate moved laterally
410 lateral edge of printing plate detected by sensor
420 if conveyor belt is vacuum conveyor belt, then vacuum is turned off
430 printing plate moved into contact with lateral alignment surface
440 printing plate rotated into alignment with lateral alignment surface
450 if conveyor belt is vacuum conveyor belt, then vacuum is turned on
460 printing plate moved away from lateral alignment surface
470 lateral edge of printing plate detected by sensor
480 position printing plate at predetermined position with respect to features on imaging drum
500 printing plates moved laterally in opposing directions
510 lateral edges of printing plates detected by sensors
520 if conveyor belts are vacuum conveyor belts, then vacuum is turned off
530 printing plates moved into contact with lateral alignment surfaces
540 printing plates independently rotated into alignment with lateral alignment surfaces
550 if conveyor belts are vacuum conveyor belts, then vacuum is turned on
560 printing plates moved away from lateral alignment surfaces in opposing directions
570 lateral edges of printing plates detected by sensors
580 position printing plates at predetermined positions with respect to features on imaging drum

1. A method for supplying a printing plate to a plate making machine, the method comprising:
pre-aligning the printing plate to an imaging drum of the plate making machine while the printing plate is moving along a plate supply path to the plate making machine.

2. A method as in claim 1, wherein the printing plate is located on a motorized shuttle carriage during the moving and pre-aligning to the imaging drum comprises rotating into alignment with a lateral alignment surface a lateral edge of the printing plate.

3. A method as in claim 2, wherein the rotating into alignment comprises moving the printing plate in a lateral translational direction to contact the lateral alignment surface.

4. A method as in claim 3, further comprising moving the printing plate away from the lateral alignment surface to a predetermined position.

5. A method as in claim 4, wherein pre-aligning to the imaging drum comprises pre-aligning the printing plate to a cylindrical axis of the imaging drum.

6. A method as in claim 3, further comprising applying a vacuum to the printing plate.

7. A method as in claim 6, further comprising removing the vacuum during the rotating.

8. A method as in claim 5, wherein the motorized shuttle carriage comprises the lateral alignment surface.

9. A method as in claim 5, wherein the lateral alignment surface comprises at least two pins.

10. A method as in claim 5, wherein moving the printing plate in a lateral translational direction is done by at least one conveyor belt.

11. A method as in claim 10, wherein the at least one conveyor belt is a vacuum conveyor belt.

12. An apparatus for supplying a printing plate along a plate supply path to an imaging drum of a plate making machine, the apparatus configured to pre-align the printing plate to the imaging drum while moving the printing plate along the plate supply path.

13. An apparatus as in claim 12, wherein the apparatus comprises a motorized shuttle carriage for moving the printing plate while the printing plate is located on the motorized shuttle carriage, and the apparatus is configured to pre-align the printing plate to the imaging drum by rotating into alignment with a lateral alignment surface a lateral edge of the printing plate.

14. An apparatus as in claim 13, wherein the motorized shuttle carriage is configured to move the printing plate in a lateral translational direction to contact the lateral alignment surface.

15. An apparatus as in claim 14, wherein the motorized shuttle carriage is further configured for moving the printing plate away from the lateral alignment surface to a predetermined position.

16. An apparatus as in claim 15, wherein the apparatus is configured to pre-align the printing plate to a cylindrical axis of the imaging drum.

17. An apparatus as in claim 16, wherein the motorized shuttle carriage comprises the lateral alignment surface.

18. An apparatus as in claim 17, wherein the lateral alignment surface comprises at least two pins.

19. An apparatus as in claim 16, wherein the motorized shuttle carriage is configured to move the printing plate in a lateral translational direction using at least one conveyor belt.

20. An apparatus as in claim 19, wherein the at least one conveyor belt is a vacuum conveyor belt.
